(19) United States
(12) Patent Application Publication
(10) Pub. No.: US 2013/0181963 A1
(43) Pub. Date: Jul. 18, 2013

(54) DRIVING APPARATUS

(71) Applicant: Raydium Semiconductor Corporation, Hsinchu (TW)

(72) Inventors: Kai-Lan Chuang, Tainan City (TW); Chien-Ru Chen, Ligang Township (TW)

(73) Assignee: Raydium Semiconductor Corporation, Hsinchu (TW)

(21) Appl. No.: 13/740,055

(22) Filed: Jan. 11, 2013

(30) Foreign Application Priority Data
Jan. 13, 2012 (TW) 101101381

(51) Int. Cl. G09G 3/36

(52) U.S. Cl. CPC G09G 3/3611
USPC 345/208; 345/87

(57) ABSTRACT

A driving apparatus applied in a liquid crystal display are disclosed. Its first channel includes a first latching module, a first level-shifting module, a P-type digital/analog converting module, a first R2R module, and a P-type amplifying module, the second channel includes a second latching module, a second level-shifting module, a N-type digital/analog converting module, a second R2R module, and a N-type amplifying module. The P-type digital/analog converting module and N-type digital/analog converting module are selectively coupled to the first R2R module or the second R2R module. The first latching module receives a first digital signal and the first latching module outputs a first analog signal corresponding to the first digital signal. The second latching module receives a second digital signal and the second latching module outputs a second analog signal corresponding to the second digital signal.

### BACKGROUND OF THE INVENTION

1. Field of the Invention

The invention relates to a liquid crystal display; in particular, to a driving apparatus applied in the liquid crystal display having a Zigzag panel.

2. Description of the Related Art

In recent years, with the development of display technology, various novel types of display apparatus having different functions and advantages are shown in the market. For example, the common liquid crystal display can use a Zigzag panel as its display panel.

Compared to an ordinary panel, the Zigzag panel will have one more data line, and a pad and two channels must be disposed in a source driver applied in a liquid crystal display having a Zigzag panel to meet the requirement of the Zigzag panel having one more data line. In addition, the conventional source driver applied in the liquid crystal display having the Zigzag panel cannot achieve the effect of offset cancel, so that the display quality of the liquid crystal display having the Zigzag panel fails to be improved.

### SUMMARY OF THE INVENTION

Therefore, the invention provides a driving apparatus applied in a liquid crystal display to solve the above-mentioned problems occurred in the prior arts.

A first embodiment of the invention is a driving apparatus. In this embodiment, the driving apparatus includes 2N channels, and the 2N channels are divided into N channel groups, and N is a positive integer. Each channel group includes a first channel and a second channel adjacent to the first channel. The first channel includes at least one first latch module, a first level shift module, a P-type digital/analog conversion module, a first resistor ladder conversion module, and a P-type amplifying module. The second channel includes at least one second latch module, a second level shift module, an N-type digital/analog conversion module, a second resistor ladder conversion module, and an N-type amplifying module.

Wherein, the first level shift module of the first channel is coupled between the at least one first latch module and the P-type digital/analog conversion module, and the second level shift module of the second channel is coupled between the at least one second latch module and the N-type digital/analog conversion module; the P-type digital/analog conversion module of the first channel and the N-type digital/analog conversion module of the second channel are selectively coupled to the first resistor ladder conversion module of the first channel or the second resistor ladder conversion module of the second channel respectively. The P-type amplifying module and the N-type amplifying module are selectively coupled to the first resistor ladder conversion module of the first channel or the second resistor ladder conversion module of the second channel respectively. The at least one first latch module of the first channel receives a first digital signal and the first resistor ladder conversion module outputs a first analog signal corresponding to the first digital signal; the at least one second latch module of the second channel receives a second digital signal and the second resistor ladder conversion module outputs a second analog signal corresponding to the second digital signal.

In an embodiment, the liquid crystal display includes a ZigZag panel and the ZigZag panel includes 2N data lines.

In an embodiment, the driving apparatus further includes (2N+2) 2-to-1 multiplexers and (N+1) output multiplexers, wherein the P-type amplifying module of the first channel is coupled to a first 2-to-1 multiplexer and a third 2-to-1 multiplexer of the (2N+2) 2-to-1 multiplexers respectively, and the N-type amplifying module of the second channel is coupled to a second 2-to-1 multiplexer and a fourth 2-to-1 multiplexer of the (2N+2) 2-to-1 multiplexers respectively, the first 2-to-1 multiplexer and the third 2-to-1 multiplexer are coupled to an external signal respectively, a first output multiplexer of the (N+1) output multiplexers is coupled to the first 2-to-1 multiplexer, the second 2-to-1 multiplexer, and a first data line and a second data line of the 2N data lines of the ZigZag panel, a second output multiplexer is coupled to the third 2-to-1 multiplexer, the fourth 2-to-1 multiplexer, and a third data line and a fourth data line of the 2N data lines of the ZigZag panel, a (N+1)th output multiplexer is coupled to a (2N−1)th 2-to-1 multiplexer, a (2N)th 2-to-1 multiplexer, and a next first data line.

In an embodiment, the driving apparatus further includes N output multiplexers and (2N+1) 2-to-1 multiplexers, wherein the P-type amplifying module of the first channel and the N-type amplifying module of the second channel are both coupled to a first output multiplexer of the N output multiplexers, and a first 2-to-1 multiplexer of the (2N+1) 2-to-1 multiplexers is coupled to the first output multiplexer, the external signal, and the first data line, a second 2-to-1 multiplexer is coupled to the first output multiplexer and the second data line, a third 2-to-1 multiplexer is coupled to the first output multiplexer, the second output multiplexer, and the third data line, and the (2N+1) 2-to-1 multiplexer is coupled to the Nth output multiplexer and the next first data line.

In an embodiment, the driving apparatus further includes N 2-to-3 multiplexers, wherein the P-type amplifying module of the first channel and the N-type amplifying module of the second channel are both coupled to a first 2-to-3 multiplexer of the N 2-to-3 multiplexers, and the first 2-to-3 multiplexer is coupled to the first data line, the second data line, and the third data line, a second 2-to-3 multiplexer is coupled to the third data line, the fourth data line, and fifth data line, the Nth 2-to-3 multiplexer is coupled to the (2N−1)th data line, the (2N)th data line, and the next first data line.

Compared to the prior art, the driving apparatus of the invention is applied in the liquid crystal display having a Zigzag panel and can meet the requirement of the Zigzag panel without adding two additional channels. In this invention, the same column of sub-pixels of the Zigzag panel will receive input voltages from the same channel of the driving apparatus at different times to achieve the effect of cancelling offset to improve the display quality of the liquid crystal display.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the driving apparatus in the first embodiment of the invention.

FIG. 2A, FIG. 2B, FIG. 2C, and FIG. 2D illustrate schematic diagrams of the signal transmission path of the driving apparatus 1 in FIG. 1 under different operation modes.

FIG. 3 illustrates a schematic diagram of the driving apparatus in the second embodiment of the invention.

FIG. 4A, FIG. 4B, FIG. 4C, and FIG. 4D illustrate schematic diagrams of the signal transmission path of the driving apparatus 3 in FIG. 3 under different operation modes.

FIG. 5 illustrates a schematic diagram of the driving apparatus in the third embodiment of the invention.

FIG. 6A, FIG. 6B, FIG. 6C, and FIG. 6D illustrate schematic diagrams of the signal transmission path of the driving apparatus 5 in FIG. 5 under different operation modes.

FIG. 7A and FIG. 7B illustrate schematic diagrams of two different types of circuit layout in the driving apparatus of the invention.

### DETAILED DESCRIPTION

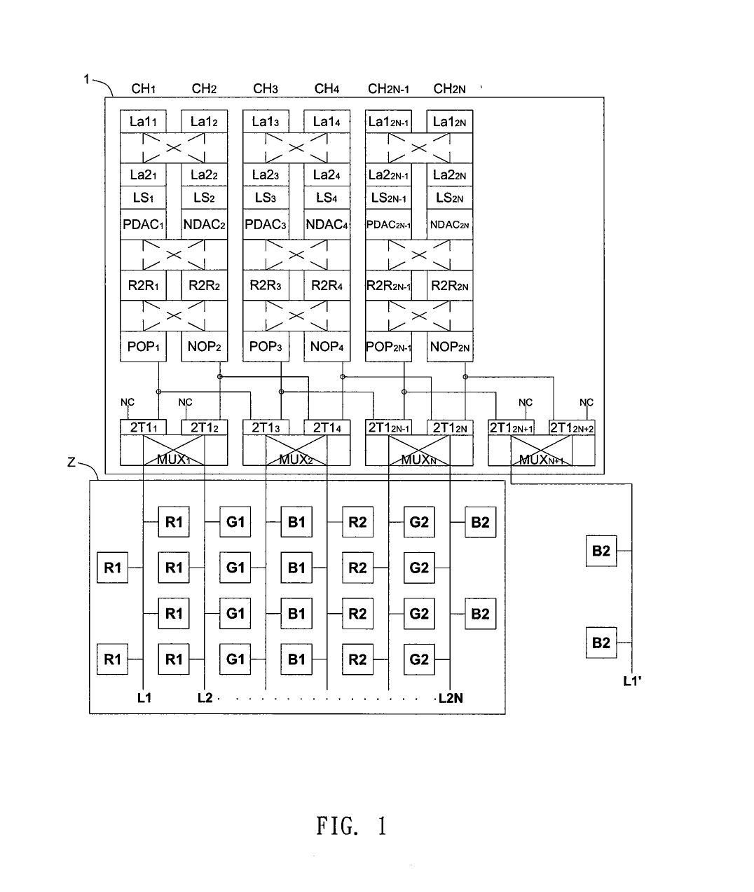

A first embodiment of the invention is a driving apparatus. In this embodiment, the driving apparatus can be a source driver applied in a liquid crystal display, but not limited to this. The liquid crystal display can be a ZigZag panel. If the same column of sub-pixels of the Zigzag panel receives input voltages from the same channel of the driving apparatus at different times, the effect of cancelling offset can be achieved to improve the display quality of the liquid crystal display. Please refer to FIG. 1. FIG. 1 illustrates a schematic diagram of the driving apparatus in this embodiment.

As shown in FIG. 1, the driving apparatus 1 includes 2N channels CH₁˜CH_{2N}, and the 2N channels CH₁˜CH_{2N} can be divided into N channel groups: CH₁ and CH₂, CH₃ and CH₄, . . . , CH_{2N-1} and CH_{2N}. Taking the first channel group CH₁ and CH₂ for an example, the channel CH₁ includes a first latch module La1₁, a second latch module La2₁, a level shift module LS₁, a P-type digital/analog conversion module PDAC₁, a resistor ladder conversion module R2R₁, and a P-type amplifying module POP₁; the channel CH₂ includes a first latch module La1₂, a second latch module La2₂, a level shift module LS₂, a N-type digital/analog conversion module NDAC₂, a resistor ladder conversion module R2R₂, and a N-type amplifying module NOP₂.

Wherein, the first latch module La1₁ of the channel CH₁ is selectively coupled to the second latch module La2₁ of the channel CH₁ or the second latch module La2₂ of the channel CH₂; the first latch module La1₂ of the channel CH₂ is selectively coupled to the second latch module La2₂ of the channel CH₂ or the second latch module La2₁ of the channel CH₁; the level shift module LS₁ of the channel CH₁ is coupled between the second latch module La2₁ and the P-type digital/analog conversion module PDAC₁; the level shift module LS₂ of the channel CH₂ is coupled between the second latch module La2₂ and the N-type digital/analog conversion module NDAC₂; the P-type digital/analog conversion module PDAC₁ of the channel CH₁ is selectively coupled to the resistor ladder conversion module R2R₁ of the channel CH₁ or the resistor ladder conversion module R2R₂ of the channel CH₂; the N-type digital/analog conversion module NDAC₂ of the channel CH₂ is selectively coupled to the resistor ladder conversion module R2R₂ of the channel CH₂ or the resistor ladder conversion module R2R₁ of the channel CH₁; the resistor ladder conversion module R2R₁ of the channel CH₁ is selectively coupled to the P-type amplifying module POP₁ of the channel CH₁ or the N-type amplifying module NOP₂ of the channel CH₂; the resistor ladder conversion module R2R₂ of the channel CH₂ is selectively coupled to the N-type amplifying module NOP₂ of the channel CH₂ or the P-type amplifying module POP₁ of the channel CH₁.

It should be noted that in this embodiment, the driving apparatus 1 also includes (2N+2) 2-to-1 multiplexers 2T1₁˜2T1_{2N+2} and (N+1) output multiplexers MUX₁˜MUX_{N+1}. Wherein, each of the 2-to-1 multiplexers 2T1₁˜2T1_{2N+2} has two input terminals and one output terminal; each of the (N+1) output multiplexers MUX₁˜MUX_{N+1} has two input terminals and two output terminals. Taking the 2-to-1 multiplexers 2T1₁˜2T1₄ for example, two input terminals of the 2-to-1 multiplexer 2T1₁ are coupled to the P-type amplifying module POP₁ of the channel CH₁ and an external signal NC respectively; two input terminals of the 2-to-1 multiplexer 2T1₂ are coupled to the N-type amplifying module NOP₂ of the channel CH₂ and the external signal NC respectively; two input terminals of the 2-to-1 multiplexer 2T1₃ are coupled to a P-type amplifying module POP₃ of the channel CH₃ and the P-type amplifying module POP₁ of the channel CH₁ respectively; two input terminals of the 2-to-1 multiplexer 2T1₄ are coupled to a N-type amplifying module NOP₄ of the channel CH₄ and the N-type amplifying module NOP₂ of the channel CH₂ respectively. Similarly, two input terminals of the 2-to-1 multiplexer 2T1_{2N+1} are coupled to the P-type amplifying module POP_{2N-1} of the channel CH_{2N-1} and the external signal NC respectively; two input terminals of the 2-to-1 multiplexer 2T1_{2N+2} are coupled to the N-type amplifying module NOP_{2N} of the channel CH_{2N} respectively.

Two input terminals of the output multiplexer MUX₁ are coupled to output terminals of the 2-to-1 multiplexers 2T1₁ and 2T1₂ respectively; two input terminals of the output multiplexer MUX₂ are coupled to output terminals of the 2-to-1 multiplexers 2T1₃ and 2T1₄ respectively; similarly, two input terminals of the output multiplexer MUX_{N} are coupled to output terminals of the 2-to-1 multiplexers 2T1_{2N-1} and 2T1_{2N} respectively; two input terminals of the output multiplexer MUX_{N+1} are coupled to output terminals of the 2-to-1 multiplexers 2T1_{2N+1} and 2T1_{2N+2} respectively.

The ZigZag panel Z includes 2N data lines L1˜L2N. It should be noted that not all of each column of sub-pixels of the Zigzag panel Z is coupled to the same data line; instead, each column of sub-pixels of the Zigzag panel Z is coupled to two data lines at two sides in an interlacing way. Taking the first column of sub-pixels R1 of the Zigzag panel Z in FIG. 1 for example, the first sub-pixel and the third sub-pixel R1 are coupled to the first data line L1, while the second sub-pixel and the fourth sub-pixel R1 are coupled to the second data line L2. Similarly, the second column of sub-pixels G1 is in the same situation, the first sub-pixel and the third sub-pixel G1 are coupled to the second data line L2, while the second sub-pixel and the fourth sub-pixel G1 are coupled to the third data line L3, and so on.

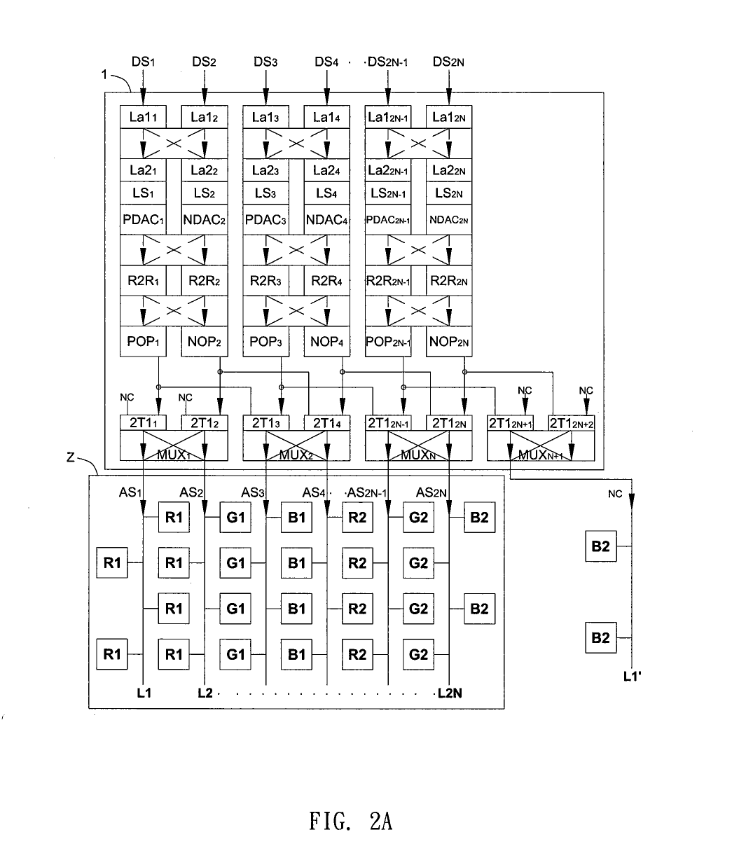

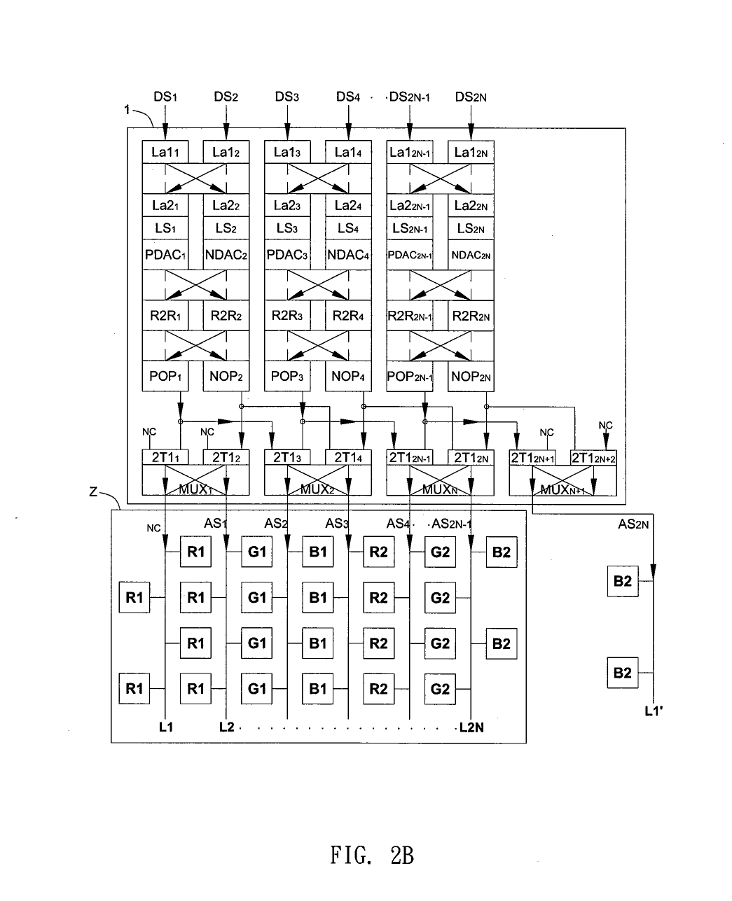

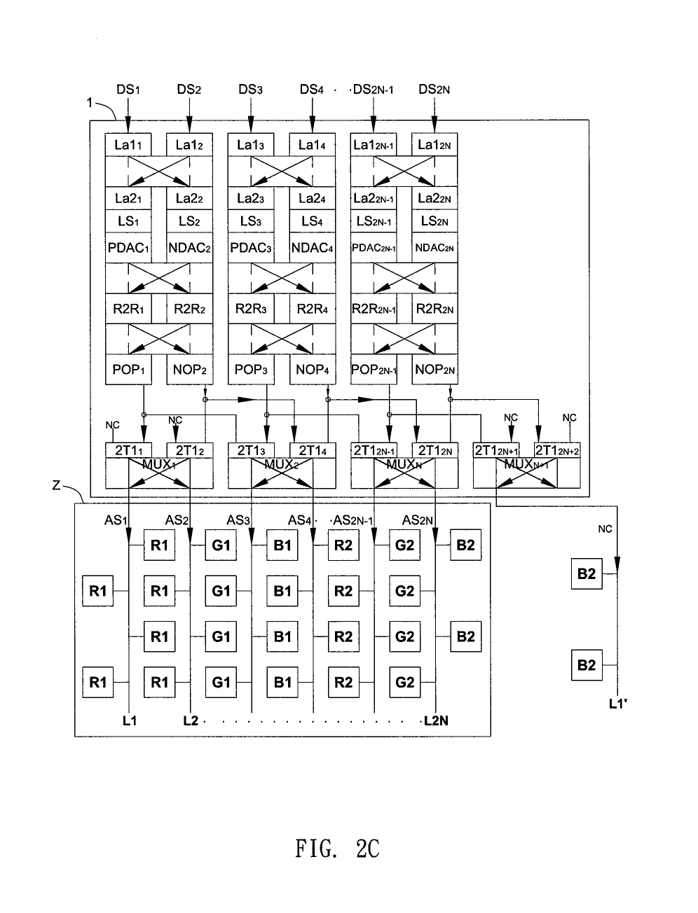

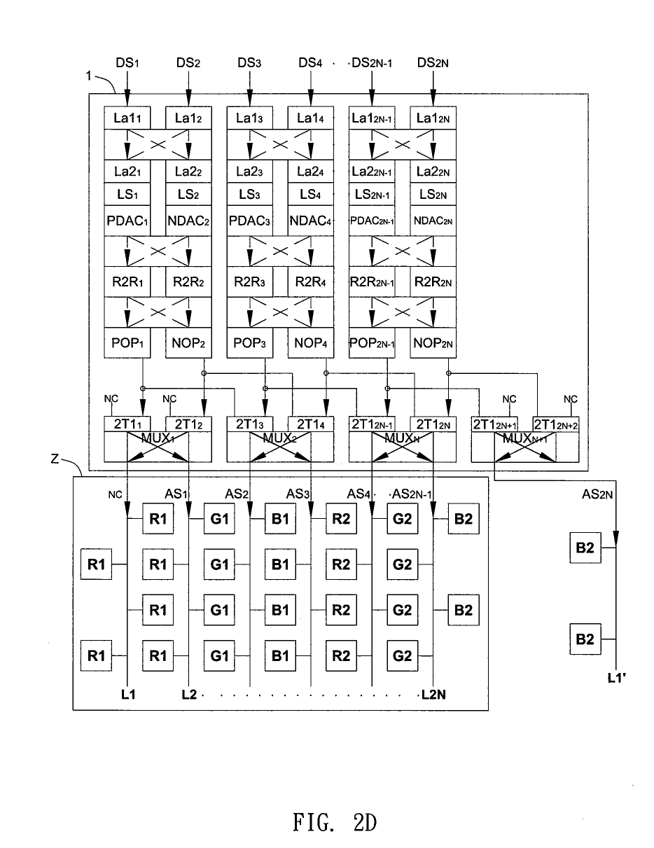

Then, please refer to FIG. 2A through FIG. 2D. FIG. 2A, FIG. 2B, FIG. 2C, and FIG. 2D illustrate schematic diagrams of the signal transmission paths of the driving apparatus 1 in FIG. 1 under different operation modes respectively.

As shown in FIG. 2A, under the first operation mode of the driving apparatus 1, when the first latch module La1₁ of the channel CH₁ receives a first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the 2-to-1 multiplexer 2T1₁, and then outputted to the first data line L1 of the ZigZag panel Z through the output multiplexer MUX₁.

When the first latch module La1₂ of the channel CH₂ receives a second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the 2-to-1 multiplexers 2T1₂, and then outputted to the second data line L2 of the ZigZag panel Z through the output multiplexer MUX₁.

Similarly, when the first latch module La1₃ of the channel CH₃ receives a third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the 2-to-1 multiplexers 2T1₃, and then outputted to the third data line L3 of the ZigZag panel Z through the output multiplexer MUX₂. When the first latch module La1₄ of the channel CH₄ receives a fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the 2-to-1 multiplexers 2T1₄, and then outputted to the fourth data line L4 of the ZigZag panel Z through the output multiplexer MUX₂, and so on.

It should be noted that the first digital signal DS₁˜the (2N)th digital signal DS_{2N} inputted into the channels CH₁˜CH_{2N} respectively are processed by the driving apparatus 1 and then outputted to the first data line L1˜the (2N)th data line L2N of the ZigZag panel Z through the 2-to-1 multiplexers 2T1₁˜2T1_{2N} and the output multiplexers MUX₁˜MUX_{N} respectively. Therefore, the 2-to-1 multiplexers 2T1_{2N+1}˜2T1_{2N+2} receive the external signal NC instead of the first digital signal DS₁˜the (2N)th digital signal DS_{2N}, and the output multiplexer MUX_{N+1} is coupled to the next first data line L1′.

As shown in FIG. 2B, under the second operation mode of the driving apparatus 1, when the first latch module La1₁ of the channel CH₁ receives a first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the 2-to-1 multiplexers 2T1₂, and then outputted to the second data line L2 of the ZigZag panel Z through the output multiplexer MUX₁.

When the first latch module La1₂ of the channel CH₂ receives a second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the 2-to-1 multiplexers 2T1₃, and then outputted to the third data line L3 of the ZigZag panel Z through the output multiplexer MUX₂.

Similarly, when the first latch module La1₃ of the channel CH₃ receives a third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the 2-to-1 multiplexers 2T1₄, and then outputted to the fourth data line L4 of the ZigZag panel Z through the output multiplexer MUX₂.

When the first latch module La1₄ of the channel CH₄ receives a fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the 2-to-1 multiplexers 2T1₅, and then outputted to the fifth data line L5 of the ZigZag panel Z through the output multiplexer MUX₃, and so on.

It should be noted that the first digital signal DS₁˜the (2N)th digital signal DS_{2N} inputted into the channels CH1˜CH2N respectively are processed by the driving apparatus 1 and then outputted to the second data line L2˜the (2N)th data line L2N and the next first data line L1′ of the ZigZag panel Z through the 2-to-1 multiplexers 2T1₂˜2T1_{2N+1} and the output multiplexers MUX₁˜MUX_{N} respectively. Therefore, the 2-to-1 multiplexers 2T1₁ and 2T1_{2N+2} receive the external signal NC instead of the first digital signal DS₁˜the (2N)th digital signal DS_{2N}, and the output multiplexer MUX_{N+1} is coupled to the next first data line L1′, so that the external signal NC received by the 2-to-1 multiplexer 2T1_{2N+1} can be outputted to the next first data line L1′ through the output multiplexer MUX_{N+1}. The external signal NC received by the 2-to-1 multiplexer 2T1₁ is outputted to the first data line L1 of the ZigZag panel Z through the output multiplexer MUX₁.

After comparing FIG. 2A with FIG. 2B, it can be found that the first analog signal AS₁˜the (2N)th analog signal AS_{2N} outputted by the driving apparatus 1 in FIG. 2A under the first operation mode are transmitted to the first data line L1˜the (2N)th data line L2N of the ZigZag panel Z respectively; the first analog signal AS₁˜the (2N)th analog signal AS_{2N} outputted by the driving apparatus 1 in FIG. 2B under the second operation mode are transmitted to the second data line L2˜the (2N)th data line L2N and the next first data line L1′ of the ZigZag panel Z respectively.

As shown in FIG. 2C, under the third operation mode of the driving apparatus 1, when the first latch module La1₁ of the channel CH₁ receives the first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the 2-to-1 multiplexer 2T1₂, and then outputted to the first data line L1 of the ZigZag panel Z through the output multiplexer MUX₁.

When the first latch module La1₂ of the channel CH₂ receives the second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the 2-to-1 multiplexers 2T1₁, and then outputted to the second data line L2 of the ZigZag panel Z through the output multiplexer MUX₁.

Similarly, when the first latch module La1₃ of the channel CH₃ receives the third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the 2-to-1 multiplexers 2T1₄, and then outputted to the third data line L3 of the ZigZag panel Z through the output multiplexer MUX₂.

When the first latch module La1₄ of the channel CH₄ receives the fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the 2-to-1 multiplexers 2T1₃, and then outputted to the fourth data line L4 of the ZigZag panel Z through the output multiplexer MUX₂, and so on.

It should be noted that the first digital signal DS₁˜the (2N)th digital signal DS_{2N} inputted into the channels CH₁˜CH_{2N} respectively are processed by the driving apparatus 1 and then outputted to the first data line L1˜the (2N)th data line L2N of the ZigZag panel Z through the 2-to-1 multiplexers 2T1₁˜2T1_{2N} and the output multiplexers MUX₁˜MUX_{N} respectively. Therefore, the 2-to-1 multiplexers 2T1_{2N+1}˜2T1_{2N+2} receive the external signal NC instead of the first digital signal DS₁˜the (2N)th digital signal DS_{2N}, and the output multiplexer MUX_{N+1} is coupled to the next first data line L1′, so that the external signal NC received by the 2-to-1 multiplexer 2T1_{2N+2} can be outputted to the next first data line L1′ through the output multiplexer MUX_{N+1}.

As shown in FIG. 2D, under the fourth operation mode of the driving apparatus 1, when the first latch module La1₁ of the channel CH₁ receives the first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the 2-to-1 multiplexers 2T1₁, and then outputted to the second data line L2 of the ZigZag panel Z through the output multiplexer MUX₁.

When the first latch module La1₂ of the channel CH₂ receives the second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the 2-to-1 multiplexers 2T1₄, and then outputted to the third data line L3 of the ZigZag panel Z through the output multiplexer MUX₂.

Similarly, when the first latch module La1₃ of the channel CH₃ receives a third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the 2-to-1 multiplexers 2T1₃, and then outputted to the fourth data line L4 of the ZigZag panel Z through the output multiplexer MUX₂. When the first latch module La1₄ of the channel CH₄ receives a fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the 2-to-1 multiplexers 2T1₆, and then outputted to the fifth data line L5 of the ZigZag panel Z through the output multiplexer MUX₃, and so on.

It should be noted that the first digital signal DS₁˜the (2N)th digital signal DS_{2N} inputted into the channels CH₁˜CH_{2N} respectively are processed by the driving apparatus 1 and then outputted to the first data line L1˜the (2N)th data line L2N and the next first data line T1′ of the ZigZag panel Z through the 2-to-1 multiplexers 2T1₁ and 2T1₃˜2T1_{2N+2} and the output multiplexers MUX₁˜MUX_{N} respectively. Therefore, the 2-to-1 multiplexers 2T1₂ and 2T1_{2N+1} receive the external signal NC instead of the first digital signal DS₁˜the (2N)th digital signal DS_{2N}, and the output multiplexer MUX_{N+1} is coupled to the next first data line L1′, so that the (2N)th analog signal AS_{2N} received by the 2-to-1 multiplexer 2T1_{2N+2} can be outputted to the next first data line L1′ through the output multiplexer MUX_{N+1}. The external signal NC received by the 2-to-1 multiplexer 2T1₂ is outputted to the first data line L1 of the ZigZag panel Z through the output multiplexer MUX₁.

After comparing FIG. 2C with FIG. 2D, it can be found that the first analog signal AS₁˜the (2N)th analog signal AS_{2N} outputted by the driving apparatus 1 in FIG. 2C under the third operation mode are transmitted to the first data line L1˜the (2N)th data line L2N of the ZigZag panel Z respectively; the first analog signal AS₁˜the (2N)th analog signal AS_{2N} outputted by the driving apparatus 1 in FIG. 2D under the fourth operation mode are transmitted to the second data line L2˜the (2N)th data line L2N and the next first data line L1′ of the ZigZag panel Z respectively.

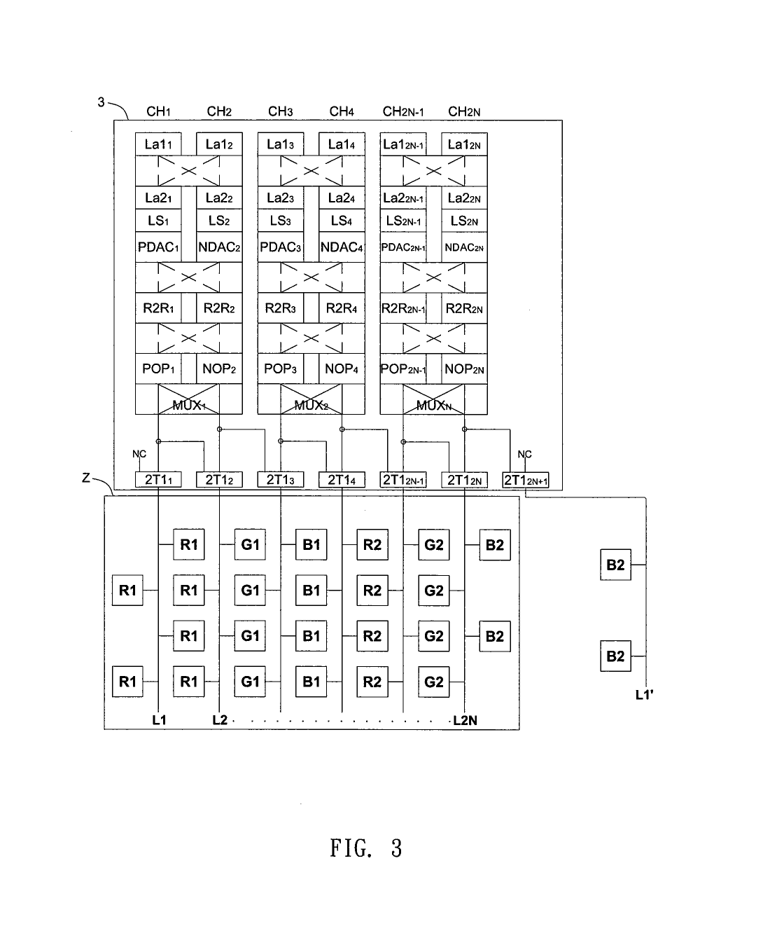

A second embodiment of the invention is a driving apparatus. In this embodiment, the driving apparatus can be a source driver applied in a liquid crystal display, but not limited to this. The liquid crystal display can be a ZigZag panel. If the same column of sub-pixels of the Zigzag panel receives input voltages from the same channel of the driving apparatus at different times, the effect of cancelling offset can be achieved to improve the display quality of the liquid crystal display. Please refer to FIG. 3. FIG. 3 illustrates a schematic diagram of the driving apparatus in this embodiment. As shown in FIG. 3, the driving apparatus 3 includes 2N channels CH₁˜CH_{2N}, and the 2N channels CH₁˜CH_{2N} can be divided into N channel groups: CH₁ and CH₂, CH₃ and CH₄, . . . , CH_{2N-1} and CH_{2N}. Taking the first channel group CH₁ and CH₂ for example, the channel CH₁ includes a first latch module La1₁, a second latch module La2₁, a level shift module LS₁, a P-type digital/analog conversion module PDAC₁, a resistor ladder conversion module R2R₁, and a P-type amplifying module POP₁; the channel CH₂ includes a first latch module La1₂, a second latch module La2₂, a level shift module LS₂, a N-type digital/analog conversion module NDAC₂, a resistor ladder conversion module R2R₂, and a N-type amplifying module NOP₂.

Wherein, the first latch module La1₁ of the channel CH₁ is selectively coupled to the second latch module La2₁ of the channel CH₁ or the second latch module La2₂ of the channel CH₂; the first latch module La1₂ of the channel CH₂ is selectively coupled to the second latch module La2₂ of the channel CH₂ or the second latch module La2₁ of the channel CH₁; the level shift module LS₁ of the channel CH₁ is coupled between the second latch module La2₁ and the P-type digital/analog conversion module PDAC₁; the level shift module LS₂ of the channel CH₂ is coupled between the second latch module La2₂ and the N-type digital/analog conversion module NDAC₂; the P-type digital/analog conversion module PDAC₁ of the channel CH₁ is selectively coupled to the resistor ladder conversion module R2R₁ of the channel CH₁ or the resistor ladder conversion module R2R₂ of the channel CH₂; the N-type digital/analog conversion module NDAC₂ of the channel CH₂ is selectively coupled to the resistor ladder conversion module R2R₂ of the channel CH₂ or the resistor ladder conversion module R2R₁ of the channel CH₁; the resistor ladder conversion module R2R₁ of the channel CH₁ is selectively coupled to the P-type amplifying module POP₁ of the channel CH₁ or the N-type amplifying module NOP₂ of the channel CH₂; the resistor ladder conversion module R2R₂ of the channel CH₂ is selectively coupled to the N-type amplifying module NOP₂ of the channel CH₂ or the P-type amplifying module POP₁ of the channel CH₁.

It should be noted that in this embodiment, the driving apparatus 3 also includes N output multiplexers MUX₁˜MUX_{N} and (2N+1) 2-to-1 multiplexers 2T1₁˜2T1_{2N+1}, each of the 2-to-1 multiplexers 2T1₁˜2T1_{2N+1} has two input terminals and one output terminal; each of the N output multiplexers MUX₁˜MUX_{N} has two input terminals and two output terminals. Taking the output multiplexers MUX₁˜MUX₄ for example, two input terminals of the output multiplexers MUX₁ are coupled to the P-type amplifying module POP₁ of the channel CH₁ and the N-type amplifying module NOP₂ of the channel CH₂, and so on. Taking the 2-to-1 multiplexers 2T1₁˜2T1₄ for example, two input terminals of the 2-to-1 multiplexer 2T1₁ are coupled to the P-type amplifying module POP₁ of the channel CH₁ and the external signal NC respectively; two input terminals of the 2-to-1 multiplexer 2T1₂ are coupled to the N-type amplifying module NOP₂ of the channel CH₂ and the P-type amplifying module POP₁ of the channel CH₁ respectively; two input terminals of the 2-to-1 multiplexer 2T1₃ are coupled to a P-type amplifying module POP₃ of the channel CH₃ and the N-type amplifying module NOP₂ of the channel CH₂ respectively; two input terminals of the 2-to-1 multiplexer 2T1₄ are coupled to a N-type amplifying module NOP₄ of the channel CH₄ and the P-type amplifying module POP₃ of the channel CH₃ respectively. Similarly, two input terminals of the 2-to-1 multiplexer 2T1_{2N+1} are coupled to the N-type amplifying module NOP_{2N} of the channel CH_{2N} and the external signal NC respectively; the output terminals of the 2-to-1 multiplexers 2T1₁˜2T1_{2N+1} are coupled to the touch pad PAD₁˜PAD_{N+1} respectively.

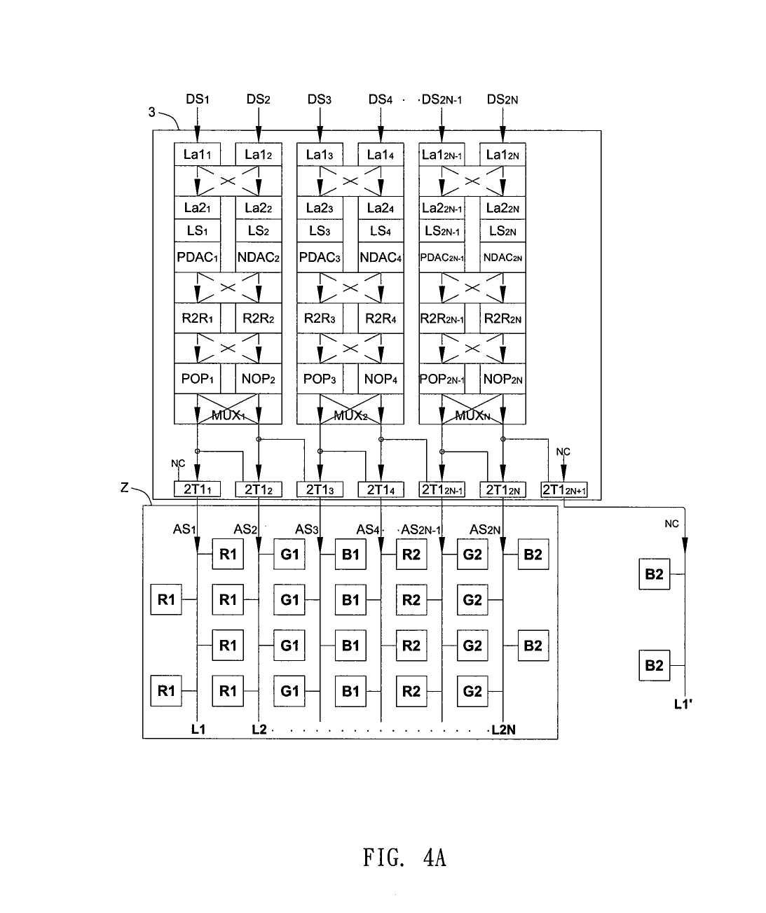

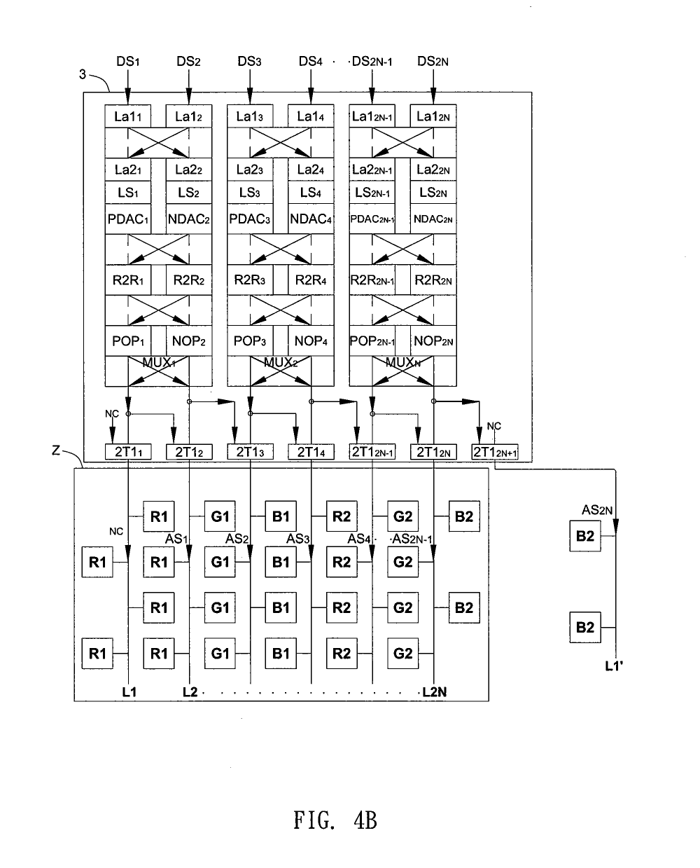

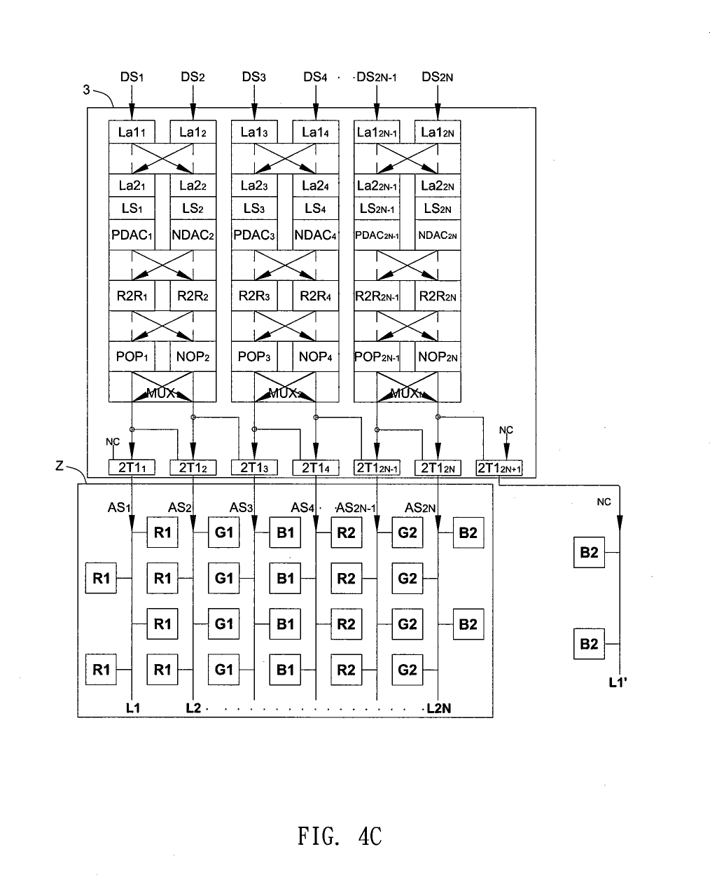

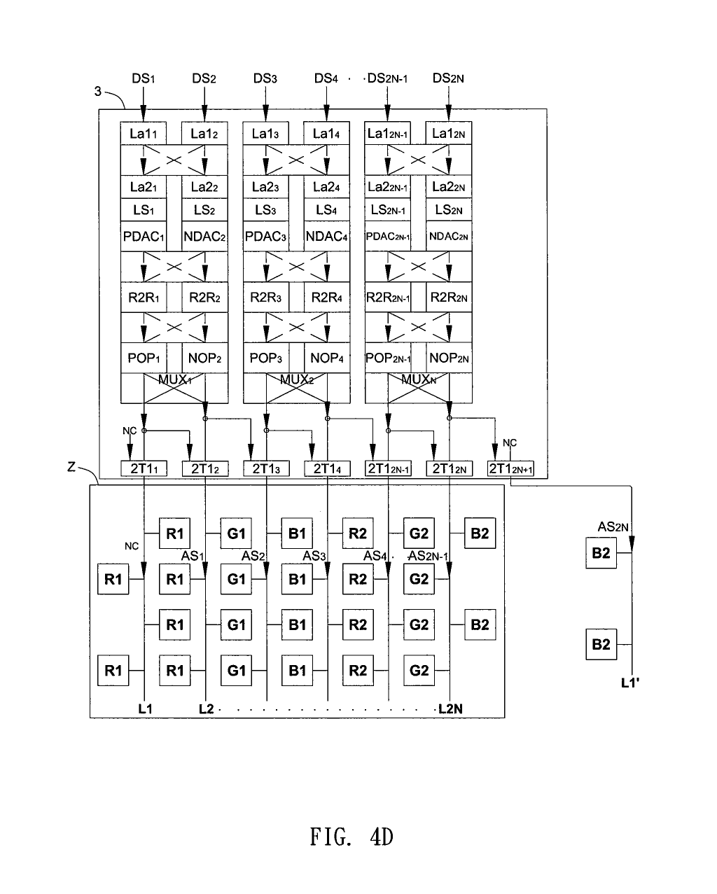

Then, please refer to FIG. 4A through FIG. 4D. FIG. 4A, FIG. 4B, FIG. 4C, and FIG. 4D illustrate schematic diagrams of the signal transmission paths of the driving apparatus 3 in FIG. 3 under different operation modes respectively.

As shown in FIG. 4A, under the first operation mode of the driving apparatus 3, when the first latch module La1₁ of the channel CH₁ receives a first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the output multiplexer MUX₁, and then outputted to the first data line L1 of the ZigZag panel Z through the 2-to-1 multiplexer 2T1₁.

When the first latch module La1₂ of the channel CH₂ receives a second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the output multiplexer MUX₁, and then outputted to the second data line L2 of the ZigZag panel Z through the 2-to-1 multiplexers 2T1₂.

Similarly, when the first latch module La1₃ of the channel CH₃ receives a third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the output multiplexer MUX₂, and then outputted to the third data line L3 of the ZigZag panel Z through the 2-to-1 multiplexers 2T1₃. When the first latch module La1₄ of the channel CH₄ receives a fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the output multiplexer MUX₂, and then outputted to the fourth data line L4 of the ZigZag panel Z through the 2-to-1 multiplexers 2T1₄, and so on.

It should be noted that the first digital signal DS₁˜the (2N)th digital signal DS_{2N} inputted into the channels CH₁˜CH_{2N} respectively are processed by the driving apparatus 3 and then outputted to the first data line L1˜the (2N)th data line L2N of the ZigZag panel Z through the output multiplexers MUX₁˜MUX_{N} and the 2-to-1 multiplexers 2T1₁˜2T1_{2N} respectively. Therefore, the 2-to-1 multiplexer 2T1_{2N+1} receives the external signal NC instead of the first digital signal DS₁˜the (2N)th digital signal DS_{2N}, and the 2-to-1 multiplexer 2T1_{2N+1} is coupled to the next first data line L1′, and the external signal NC received by the 2-to-1 multiplexer 2T1_{2N+1} can be transmitted to the next first data line L1′.

As shown in FIG. 4B, under the second operation mode of the driving apparatus 3, when the first latch module La1₁ of the channel CH₁ receives the first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the output multiplexer MUX₁, and then outputted to the second data line L2 of the ZigZag panel Z through the 2-to-1 multiplexers 2T1₂.

When the first latch module La1₂ of the channel CH₂ receives the second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the output multiplexer MUX₁, and then outputted to the third data line L3 of the ZigZag panel Z through the 2-to-1 multiplexers 2T1₃.

Similarly, when the first latch module La1₃ of the channel CH₃ receives the third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the output multiplexer MUX₂, and then outputted to the fourth data line L4 of the ZigZag panel Z through the 2-to-1 multiplexers 2T1₄.

When the first latch module La1₄ of the channel CH₄ receives a fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the output multiplexer MUX₂, and then outputted to the fifth data line L5 of the ZigZag panel Z through the 2-to-1 multiplexers 2T1₅, and so on.

It should be noted that the first digital signal DS₁˜the (2N)th digital signal DS_{2N} inputted into the channels CH₁˜CH_{2N} respectively are processed by the driving apparatus 3 and then outputted to the second data line L2˜the (2N)th data line L2N and the next first data line L1′ of the ZigZag panel Z through the output multiplexers MUX₁˜MUX_{N} and the 2-to-1 multiplexers 2T1_{2N+1} respectively. Therefore, the 2-to-1 multiplexers 2T1₁ receives the external signal NC instead of the first digital signal DS₁˜the (2N)th digital signal DS_{2N}, and the 2-to-1 multiplexer 2T1_{2N+1} is coupled to the next first data line L1′, so that the (2N)th digital signal DS_{2N} received by the 2-to-1 multiplexer 2T1_{2N+1} can be outputted to the next first data line L1′ through the output multiplexer MUX_{N+1}. The external signal NC received by the 2-to-1 multiplexer 2T1₁ is outputted to the first data line L1 of the ZigZag panel Z.

After comparing FIG. 4A with FIG. 4B, it can be found that the first analog signal AS₁˜the (2N)th analog signal AS_{2N} outputted by the driving apparatus 3 in FIG. 4A under the first operation mode are transmitted to the first data line L1˜the (2N)th data line L2N of the ZigZag panel Z respectively; the first analog signal AS₁˜the (2N)th analog signal AS_{2N} outputted by the driving apparatus 3 in FIG. 4B under the second operation mode are transmitted to the second data line L2˜the (2N)th data line L2N and the next first data line L1′ of the ZigZag panel Z respectively.

As shown in FIG. 4C, under the third operation mode of the driving apparatus 3, when the first latch module La1₁ of the channel CH₁ receives the first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the output multiplexer MUX₁, and then outputted to the first data line L1 of the ZigZag panel Z through the 2-to-1 multiplexers 2T1₂.

When the first latch module La1₂ of the channel CH₂ receives the second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the output multiplexer MUX₁, and then outputted to the second data line L2 of the ZigZag panel Z through the 2-to-1 multiplexers 2T1₂.

Similarly, when the first latch module La1₃ of the channel CH₃ receives the third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the output multiplexer MUX₂, and then outputted to the third data line L3 of the ZigZag panel Z through the 2-to-1 multiplexers 2T1₃.

When the first latch module La1₄ of the channel CH₄ receives the fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the output multiplexer MUX₂, and then outputted to the fourth data line L4 of the ZigZag panel Z through the 2-to-1 multiplexers 2T1₄, and so on.

It should be noted that the first digital signal DS₁˜the (2N)th digital signal DS_{2N} inputted into the channels CH₁˜CH_{2N} respectively are processed by the driving apparatus 3 and then outputted to the first data line L1˜the (2N)th data line L2N of the ZigZag panel Z through the output multiplexers MUX₁˜MUX_{N} and 2-to-1 multiplexers 2T1₁˜2T1_{2N} respectively. Therefore, the 2-to-1 multiplexer 2T1_{2N+1} receives the external signal NC instead of the first digital signal DS₁˜the (2N)th digital signal DS_{2N}, and the 2-to-1 multiplexer 2T1_{2N+1} is coupled to the next first data line L1′, so that the external signal NC received by the 2-to-1 multiplexer 2T1_{2N+1} can be outputted to the next first data line L1′.

As shown in FIG. 4D, under the fourth operation mode of the driving apparatus 3, when the first latch module La1₁ of the channel CH₁ receives the first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the output multiplexer MUX₁, and then outputted to the second data line L2 of the ZigZag panel Z through the 2-to-1 multiplexers 2T1₂.

When the first latch module La1₂ of the channel CH₂ receives the second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the output multiplexer MUX₁, and then outputted to the third data line L3 of the ZigZag panel Z through the 2-to-1 multiplexers 2T1₃.

Similarly, when the first latch module La1₃ of the channel CH₃ receives the third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the output multiplexer MUX₂, and then outputted to the fourth data line L4 of the ZigZag panel Z through the 2-to-1 multiplexers 2T1₄. When the first latch module La1₄ of the channel CH₄ receives the fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the output multiplexer MUX₂, and then outputted to the fifth data line L5 of the ZigZag panel Z through the 2-to-1 multiplexers 2T1₅, and so on.

It should be noted that the first digital signal DS₁˜the (2N)th digital signal DS_{2N} inputted into the channels CH₁˜CH_{2N} respectively are processed by the driving apparatus 3 and then outputted to the first data line L1˜the (2N)th data line L2N and the next first data line T1′ of the ZigZag panel Z through the output multiplexers MUX₁˜MUX_{N} and the 2-to-1 multiplexers 2T1_{2N+1} respectively. Therefore, the 2-to-1 multiplexers 2T1₁ receives the external signal NC instead of the first digital signal DS₁˜the (2N)th digital signal DS_{2N}, and the 2-to-1 multiplexer 2T1_{2N+1} is coupled to the next first data line L1′, so that the (2N)th analog signal AS_{2N} received by the 2-to-1 multiplexer 2T1_{2N+1} can be outputted to the next first data line L1′. The external signal NC received by the 2-to-1 multiplexer 2T1₁ is outputted to the first data line L1 of the ZigZag panel Z.

After comparing FIG. 4C with FIG. 4D, it can be found that the first analog signal AS₁˜the (2N)th analog signal AS_{2N} outputted by the driving apparatus 3 in FIG. 4C under the third operation mode are transmitted to the first data line L1˜the (2N)th data line L2N of the ZigZag panel Z respectively; the first analog signal AS₁˜the (2N)th analog signal AS_{2N} outputted by the driving apparatus 3 in FIG. 4D under the fourth operation mode are transmitted to the second data line L2˜the (2N)th data line L2N and the next first data line L1′ of the ZigZag panel Z respectively.

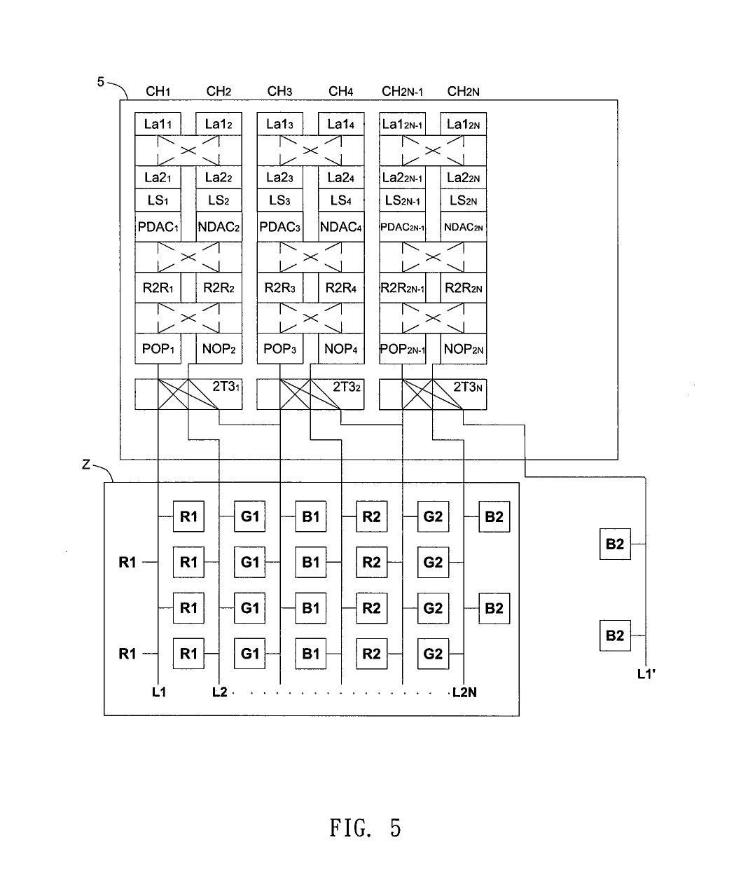

A third embodiment of the invention is a driving apparatus. In this embodiment, the driving apparatus can be a source driver applied in a liquid crystal display, but not limited to this. The liquid crystal display can be a ZigZag panel. If the same column of sub-pixels of the Zigzag panel receives input voltages from the same channel of the driving apparatus at different times, the effect of cancelling offset can be achieved to improve the display quality of the liquid crystal display. Please refer to FIG. 5. FIG. 5 illustrates a schematic diagram of the driving apparatus in this embodiment. As shown in FIG. 5, the driving apparatus 5 includes 2N channels CH₁˜CH_{2N}, and the 2N channels CH₁˜CH_{2N} can be divided into N channel groups: CH₁ and CH₂, CH₃ and CH₄, . . . , CH_{2N-1} and CH_{2N}. Taking the first channel group CH₁ and CH₂ for example, the channel CH₁ includes a first latch module La1₁, a second latch module La2₁, a level shift module LS₁, a P-type digital/analog conversion module PDAC₁, a resistor ladder conversion module R2R₁, and a P-type amplifying module POP₁; the channel CH₂ includes a first latch module La1₂, a second latch module La2₂, a level shift module LS₂, a N-type digital/analog conversion module NDAC₂, a resistor ladder conversion module R2R₂, and a N-type amplifying module NOP₂.

Wherein, the first latch module La1₁ of the channel CH₁ is selectively coupled to the second latch module La2₁ of the channel CH₁ or the second latch module La2₂ of the channel CH₂; the first latch module La1₂ of the channel CH₂ is selectively coupled to the second latch module La2₂ of the channel CH₂ or the second latch module La2₁ of the channel CH₁; the level shift module LS₁ of the channel CH₁ is coupled between the second latch module La2₁ and the P-type digital/analog conversion module PDAC₁; the level shift module LS₂ of the channel CH₂ is coupled between the second latch module La2₂ and the N-type digital/analog conversion module NDAC₂; the P-type digital/analog conversion module PDAC₁ of the channel CH₁ is selectively coupled to the resistor ladder conversion module R2R₁ of the channel CH₁ or the resistor ladder conversion module R2R₂ of the channel CH₂; the N-type digital/analog conversion module NDAC₂ of the channel CH₂ is selectively coupled to the resistor ladder conversion module R2R₂ of the channel CH₂ or the resistor ladder conversion module R2R₁ of the channel CH₁; the resistor ladder conversion module R2R₁ of the channel CH₁ is selectively coupled to the P-type amplifying module POP₁ of the channel CH₁ or the N-type amplifying module NOP₂ of the channel CH₂; the resistor ladder conversion module R2R₂ of the channel CH₂ is selectively coupled to the N-type amplifying module NOP₂ of the channel CH₂ or the P-type amplifying module POP₁ of the channel CH₁.

It should be noted that in this embodiment, the driving apparatus 5 also includes N 2-to-3 multiplexers 2T3₁˜2T3_{N}. Each of the 2-to-3 multiplexers 2T3₁˜2T3_{N} has two input terminals and three output terminals. Wherein, two input terminals of the 2-to-3 multiplexer 2T3₁ are coupled to the P-type amplifying module POP₁ of the channel CH₁ and the N-type amplifying module NOP₂ of the channel CH₂, two input terminals of the 2-to-3 multiplexer 2T3₂ are coupled to the P-type amplifying module POP₃ of the channel CH₃ and the N-type amplifying module NOP₄ of the channel CH₄, and so on. The three input terminals of the 2-to-3 multiplexer 2T3₁ are coupled to the first data line L1˜the third data line L3; the three input terminals of the 2-to-3 multiplexer 2T3₂ are coupled to the third data line L3˜the fifth data line L5, and so on.

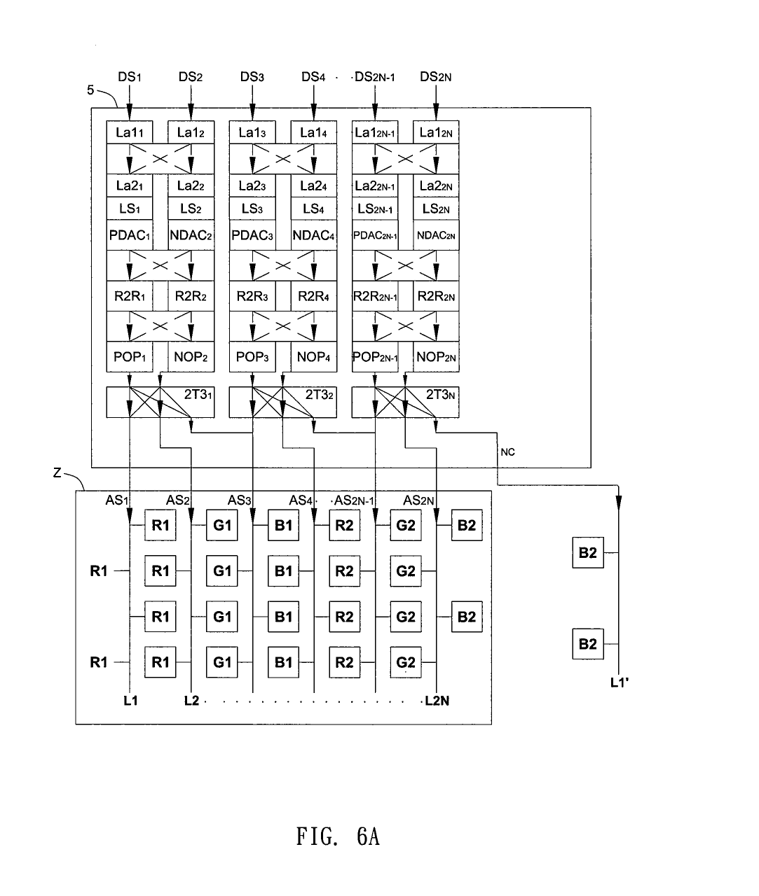

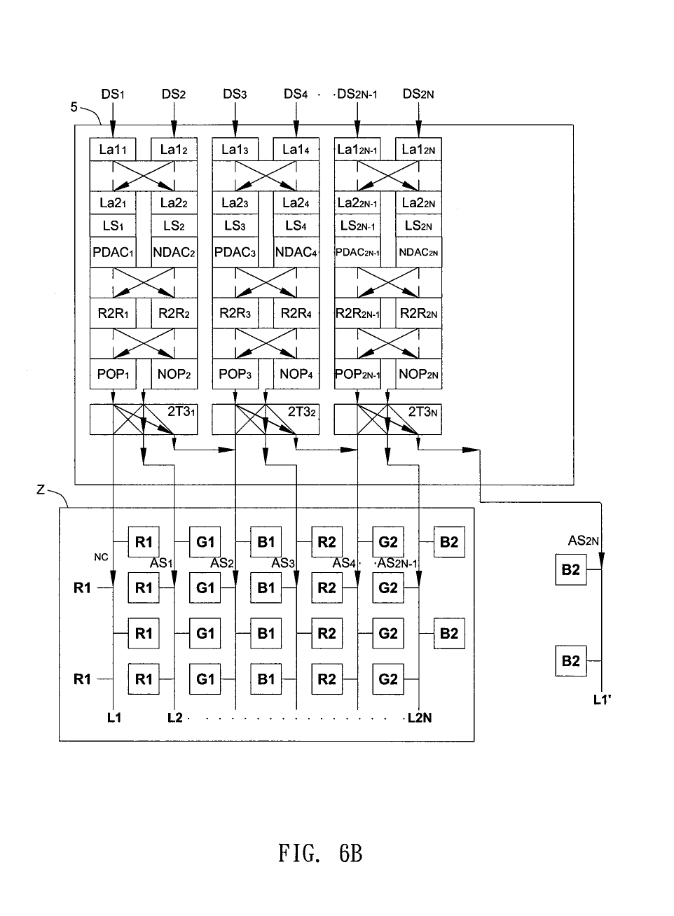

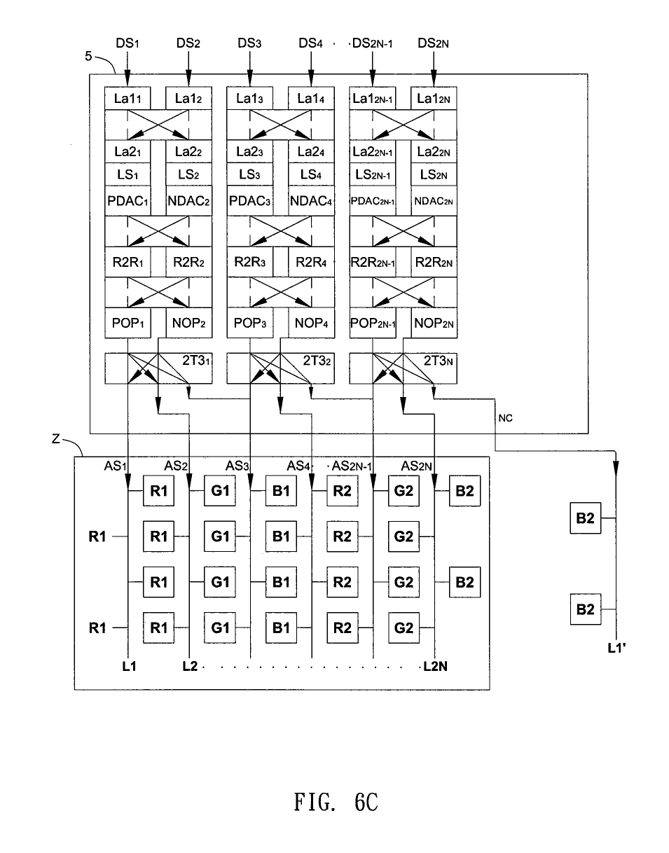

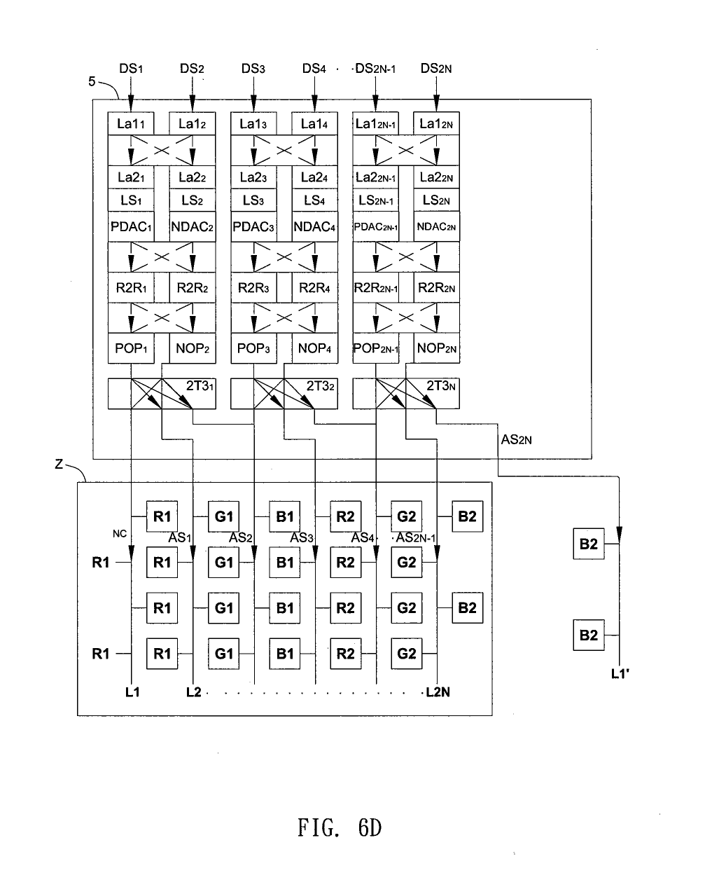

Then, please refer to FIG. 6A through FIG. 6D. FIG. 6A, FIG. 6B, FIG. 6C, and FIG. 6D illustrate schematic diagrams of the signal transmission paths of the driving apparatus 5 in FIG. 5 under different operation modes respectively.

As shown in FIG. 6A, under the first operation mode of the driving apparatus 5, when the first latch module La1₁ of the channel CH₁ receives the first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the 2-to-3 multiplexer 2T3₁, and then outputted to the first data line L1 of the ZigZag panel Z through the 2-to-3 multiplexer 2T3₁.

When the first latch module La1₂ of the channel CH₂ receives the second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the 2-to-3 multiplexer 2T3₁, and then outputted to the second data line L2 of the ZigZag panel Z through the 2-to-3 multiplexer 2T3₁.

Similarly, when the first latch module La1₃ of the channel CH₃ receives the third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the 2-to-3 multiplexer 2T3₂, and then outputted to the third data line L3 of the ZigZag panel Z through the 2-to-3 multiplexer 2T3₂. When the first latch module La1₄ of the channel CH₄ receives the fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the 2-to-3 multiplexer 2T3₂, and then outputted to the fourth data line L4 of the ZigZag panel Z through the 2-to-3 multiplexer 2T3₂, and so on. By doing so, the first digital signal DS₁˜the (2N)th digital signal DS_{2N} inputted into the channels CH₁˜CH_{2N} respectively are processed by the driving apparatus 5 and then outputted to the first data line L1˜the (2N)th data line L2N of the ZigZag panel Z through the 2-to-3 multiplexers 2T3₁˜2T3_{N} respectively.

As shown in FIG. 6B, under the second operation mode of the driving apparatus 5, when the first latch module La1₁ of the channel CH₁ receives the first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the 2-to-3 multiplexer 2T3₁, and then outputted to the second data line L2 of the ZigZag panel Z through the 2-to-3 multiplexer 2T3₁.

When the first latch module La1₂ of the channel CH₂ receives the second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the 2-to-3 multiplexer 2T3₁, and then outputted to the third data line L3 of the ZigZag panel Z through the 2-to-3 multiplexer 2T3₁.

Similarly, when the first latch module La1₃ of the channel CH₃ receives the third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the 2-to-3 multiplexer 2T3₂, and then outputted to the fourth data line L4 of the ZigZag panel Z through the 2-to-3 multiplexers 2T3₂.

When the first latch module La1₄ of the channel CH₄ receives the fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the 2-to-3 multiplexer 2T3₂, and then outputted to the fifth data line L5 of the ZigZag panel Z through the 2-to-3 multiplexer 2T3₂, and so on.

It should be noted that the first digital signal DS₁˜the (2N)th digital signal DS_{2N} inputted into the channels CH₁˜CH_{2N} respectively are processed by the driving apparatus 5 and then outputted to the second data line L2˜the (2N)th data line L2N and the next first data line L1′ of the ZigZag panel Z through the 2-to-3 multiplexers 2T3₁˜2T3_{N} respectively. Therefore, the 2-to-3 multiplexer 2T3₁ has to transmit the external signal NC to the first data line L1 of the ZigZag panel Z. In addition, the 2-to-3 multiplexer 2T3_{N} is coupled to the next first data line L1′, the (2N)th digital signal DS_{2N} received by the 2-to-3 multiplexer 2T3_{N} is outputted to the next first data line L1′ through the 2-to-3 multiplexer 2T3_{N}.

After comparing FIG. 6A with FIG. 6B, it can be found that the first analog signal AS₁˜the (2N)th analog signal AS_{2N} outputted by the driving apparatus 5 in FIG. 6A under the first operation mode are transmitted to the first data line L1˜the (2N)th data line L2N of the ZigZag panel Z respectively; the first analog signal AS₁˜the (2N)th analog signal AS_{2N} outputted by the driving apparatus 5 in FIG. 6B under the second operation mode are transmitted to the second data line L2˜the (2N)th data line L2N and the next first data line L1′ of the ZigZag panel Z respectively.

As shown in FIG. 6C, under the third operation mode of the driving apparatus 5, when the first latch module La1₁ of the channel CH₁ receives the first digital signal DS₁, the first latch module La1₁ transmits the first digital signal DS₁ to the second latch module La2₂ of the channel CH₂. Then, after the first digital signal DS₁ is processed by the level shift module LS₂ and the N-type digital/analog conversion module NDAC₂ of the channel CH₂, the resistor ladder conversion module R2R₁ of the channel CH₁, and the N-type amplifying module NOP₂ of the channel CH₂, the first digital signal DS₁ is converted into the first analog signal AS₁ and the first analog signal AS₁ is transmitted to the 2-to-3 multiplexer 2T3₁, and then outputted to the first data line L1 of the ZigZag panel Z through the 2-to-3 multiplexer 2T3₁.

When the first latch module La1₂ of the channel CH₂ receives the second digital signal DS₂, the first latch module La1₂ transmits the second digital signal DS₂ to the second latch module La2₁ of the channel CH₁. Then, after the second digital signal DS₂ is processed by the level shift module LS₁ and the P-type digital/analog conversion module PDAC₁ of the channel CH₁, the resistor ladder conversion module R2R₂ of the channel CH₂, and the P-type amplifying module POP₁ of the channel CH₁, the second digital signal DS₂ is converted into the second analog signal AS₂ and the second analog signal AS₂ is transmitted to the 2-to-3 multiplexer 2T3₁, and then outputted to the second data line L2 of the ZigZag panel Z through the 2-to-3 multiplexer 2T3₁.

Similarly, when the first latch module La1₃ of the channel CH₃ receives the third digital signal DS₃, the first latch module La1₃ transmits the third digital signal DS₃ to the second latch module La2₄ of the channel CH₄. Then, after the third digital signal DS₃ is processed by the level shift module LS₄ and the N-type digital/analog conversion module NDAC₄ of the channel CH₄, the resistor ladder conversion module R2R₃ of the channel CH₃, and the N-type amplifying module NOP₄ of the channel CH₄, the third digital signal DS₃ is converted into the third analog signal AS₃ and the third analog signal AS₃ is transmitted to the 2-to-3 multiplexer 2T3₂, and then outputted to the third data line L3 of the ZigZag panel Z through the 2-to-3 multiplexers 2T3₂.

When the first latch module La1₄ of the channel CH₄ receives the fourth digital signal DS₄, the first latch module La1₄ transmits the fourth digital signal DS₄ to the second latch module La2₃ of the channel CH₃. Then, after the fourth digital signal DS₄ is processed by the level shift module LS₃ and the P-type digital/analog conversion module PDAC₃ of the channel CH₃, the resistor ladder conversion module R2R₄ of the channel CH₄, and the P-type amplifying module POP₃ of the channel CH₃, the fourth digital signal DS₄ is converted into the fourth analog signal AS₄ and the fourth analog signal AS₄ is transmitted to the 2-to-3 multiplexer 2T3₂, and then outputted to the fourth data line L4 of the ZigZag panel Z through the 2-to-3 multiplexer 2T3₂, and so on. By doing so, the first digital signal DS₁˜the (2N)th digital signal DS_{2N} inputted into the channels CH₁˜CH_{2N} respectively are processed by the driving apparatus 5 and then outputted to the first data line L1˜the (2N)th data line L2N of the ZigZag panel Z through the 2-to-3 multiplexers 2T3₁˜2T3_{N} respectively.

As shown in FIG. 6D, under the fourth operation mode of the driving apparatus 5, when the first latch module La1₁ of the channel CH₁ receives the first digital signal DS₁, the first latch module La1₁ transmits the first digital signal DS₁ to the second latch module La2₁ of the channel CH₁. Then, after the first digital signal DS₁ is processed by the level shift module LS₁, the P-type digital/analog conversion module PDAC₁, the resistor ladder conversion module R2R₁, and the P-type amplifying module POP₁ of the channel CH₁, the first digital signal DS₁ is converted into a first analog signal AS₁ and the first analog signal AS₁ is transmitted to the 2-to-3 multiplexer 2T3₁, and then outputted to the second data line L2 of the ZigZag panel Z through the 2-to-3 multiplexer 2T3₁.

When the first latch module La1₂ of the channel CH₂ receives the second digital signal DS₂, the first latch module La1₂ transmits the second digital signal DS₂ to the second latch module La2₂ of the channel CH₂. Then, after the second digital signal DS₂ is processed by the level shift module LS₂, the N-type digital/analog conversion module NDAC₂, the resistor ladder conversion module R2R₂, and the N-type amplifying module NOP₂ of the channel CH₂, the second digital signal DS₂ is converted into a second analog signal AS₂ and the second analog signal AS₂ is transmitted to the 2-to-3 multiplexer 2T3₁, and then outputted to the third data line L3 of the ZigZag panel Z through the 2-to-3 multiplexer 2T3₁.

Similarly, when the first latch module La1₃ of the channel CH₃ receives the third digital signal DS₃, the first latch module La1₃ transmits the third digital signal DS₃ to the second latch module La2₃ of the channel CH₃. Then, after the third digital signal DS₃ is processed by the level shift module LS₃, the P-type digital/analog conversion module PDAC₃, the resistor ladder conversion module R2R₃, and the P-type amplifying module POP₃ of the channel CH₃, the third digital signal DS₃ is converted into a third analog signal AS₃ and the third analog signal AS₃ is transmitted to the 2-to-3 multiplexer 2T3₂, and then outputted to the fourth data line L4 of the ZigZag panel Z through the 2-to-3 multiplexer 2T3₂. When the first latch module La1₄ of the channel CH₄ receives the fourth digital signal DS₄, the first latch module La1₄ transmits the fourth digital signal DS₄ to the second latch module La2₄ of the channel CH₄. Then, after the fourth digital signal DS₄ is processed by the level shift module LS₄, the N-type digital/analog conversion module NDAC₄, the resistor ladder conversion module R2R₄, and the N-type amplifying module NOP₄ of the channel CH₄, the fourth digital signal DS₄ is converted into a fourth analog signal AS₄ and the fourth analog signal AS₄ is transmitted to the 2-to-3 multiplexer 2T3₂, and then outputted to the fifth data line L5 of the ZigZag panel Z through the 2-to-3 multiplexer 2T3₂, and so on.

It should be noted that the first digital signal DS₁˜the (2N)th digital signal DS_{2N} inputted into the channels CH₁˜CH_{2N} respectively are processed by the driving apparatus 5 and then outputted to the first data line L2˜the (2N)th data line L2N and the next first data line T1′ of the ZigZag panel Z through the 2-to-3 multiplexers 2T3₁˜2T3_{N} respectively. Therefore, the 2-to-3 multiplexer 2T3₁ outputs the external signal NC to the next first data line T1′, and the 2-to-3 multiplexer 2T3_{N} is coupled to the next first data line L1′, so that the (2N)th analog signal AS_{2N} received by the 2-to-3 multiplexer 2T3_{N} can be outputted to the next first data line L1′.

After comparing FIG. 6C with FIG. 6D, it can be found that the first analog signal AS₁˜the (2N)th analog signal AS_{2N} outputted by the driving apparatus 5 in FIG. 6C under the third operation mode are transmitted to the first data line L1˜the (2N)th data line L2N of the ZigZag panel Z respectively; the first analog signal AS₁˜the (2N)th analog signal AS_{2N} outputted by the driving apparatus 5 in FIG. 6D under the fourth operation mode are transmitted to the second data line L2˜the (2N)th data line L2N and the next first data line L1′ of the ZigZag panel Z respectively.

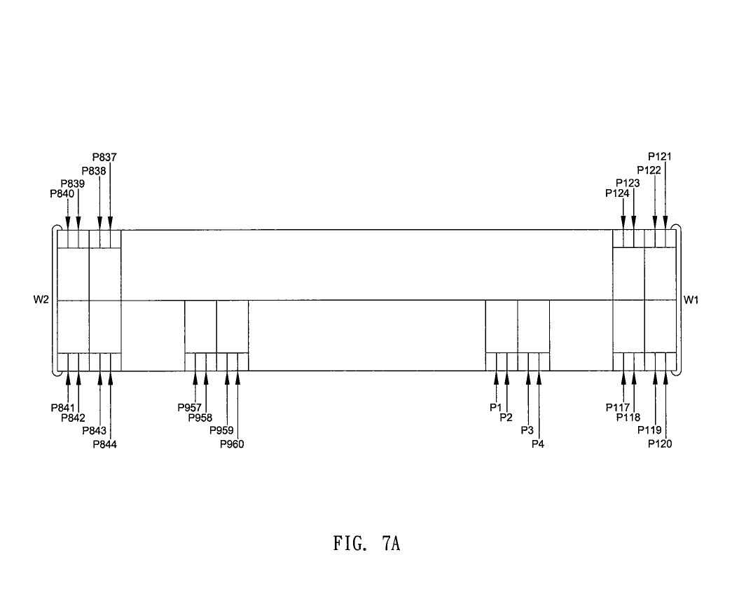

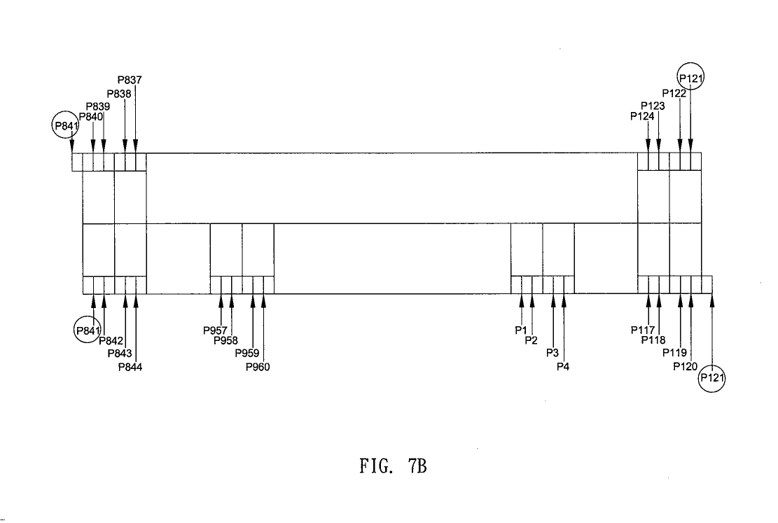

FIG. 7A and FIG. 7B illustrate schematic diagrams of two different types of circuit layout in the driving apparatus of the invention. It is assumed that the driving apparatus includes 960 channels. As shown in FIG. 7A, the pins P120 and P121 are disposed at two sides of the circuit board and they can be coupled by a wire W1; similarly, the pins P840 and P841 are disposed at two sides of the circuit board and they can be coupled by a wire W2. However, additional resistance will be generated, and the compensating resistor is necessary in the circuit to compensate. In order to reduce additional resistance generated by the coupling wires, as shown in FIG. 7B, a pin which is the same with the pin P121 is additionally disposed near the pin P120, and a pin which is the same with the pin P841 is additionally disposed near the pin P840, so that the compensating resistor is not necessary.

Compared to the prior art, the driving apparatus of the invention is applied in the liquid crystal display having a Zigzag panel and can meet the requirement of the Zigzag panel without adding two additional channels. In this invention, the same column of sub-pixels of the Zigzag panel will receives input voltages from the same channel of the driving apparatus at different times to achieve the effect of cancelling offset to improve the display quality of the liquid crystal display.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A driving apparatus, applied to a liquid crystal display, the driving apparatus comprising:
2N channels, divided into N channel groups, N being a positive integer, each channel group comprising a first channel and a second channel adjacent to the first channel, the first channel comprising at least one first latch module, a first level shift module, a P-type digital/analog conversion module, a first resistor ladder conversion module, and a P-type amplifying module, and the second channel comprising at least one second latch module, a second level shift module, a N-type digital/analog conversion module, a second resistor ladder conversion module, and a N-type amplifying module;
wherein the first level shift module of the first channel is coupled between the at least one first latch module and the P-type digital/analog conversion module, and the second level shift module of the second channel is coupled between the at least one second latch module and the N-type digital/analog conversion module; the P-type digital/analog conversion module of the first channel and the N-type digital/analog conversion module of the second channel are selectively coupled to the first resistor ladder conversion module of the first channel or the second resistor ladder conversion module of the second channel respectively; the P-type amplifying module and the N-type amplifying module are selectively coupled to the first resistor ladder conversion module of the first channel or the second resistor ladder conversion module of the second channel respectively;
wherein the at least one first latch module of the first channel receives a first digital signal and the first resistor ladder conversion module outputs a first analog signal corresponding to the first digital signal; the at least one second latch module of the second channel receives a second digital signal and the second resistor ladder conversion module outputs a second analog signal corresponding to the second digital signal.

2. The driving apparatus of claim 1, wherein the liquid crystal display comprises a ZigZag panel and the ZigZag panel comprises 2N data lines.

3. The driving apparatus of claim 2, further comprising (2N+2) 2-to-1 multiplexers and (N+1) output multiplexers, wherein the P-type amplifying module of the first channel is coupled to a first 2-to-1 multiplexer and a third 2-to-1 multiplexer of the (2N+2) 2-to-1 multiplexers respectively, and the N-type amplifying module of the second channel is coupled to a second 2-to-1 multiplexer and a fourth 2-to-1 multiplexer of the (2N+2) 2-to-1 multiplexers respectively, the first 2-to-1 multiplexer and the third 2-to-1 multiplexer are coupled to an external signal respectively, a first output multiplexer of the (N+1) output multiplexers is coupled to the first 2-to-1 multiplexer, the second 2-to-1 multiplexer, and a first data line and a second data line of the 2N data lines of the ZigZag panel, a second output multiplexer is coupled to the third 2-to-1 multiplexer, the fourth 2-to-1 multiplexer, and a third data line and a fourth data line of the 2N data lines of the ZigZag panel, a (N+1)th output multiplexer is coupled to a (2N−1)th 2-to-1 multiplexer, a (2N)th 2-to-1 multiplexer, and a next first data line.

4. The driving apparatus of claim 3, wherein under a first operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first output multiplexer is coupled between the first 2-to-1 multiplexer and the first data line and coupled between the second 2-to-1 multiplexer and the second data line, the first analog signal outputted by the first resistor ladder conversion module is amplified by the P-type amplifying module and then outputted to the first data line through the first 2-to-1 multiplexer and the first output multiplexer, the second analog signal outputted by the second resistor ladder conversion module is amplified by the N-type amplifying module and then outputted to the second data line through the second 2-to-1 multiplexer and the first output multiplexer, and the (N+1)th output multiplexer output the external signal received by the (2N−1)th 2-to-1 multiplexer to the next first data line; under a second operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first output multiplexer is coupled between the first 2-to-1 multiplexer and the first data line and coupled between the second 2-to-1 multiplexer and the second data line, the first analog signal outputted by the first resistor ladder conversion module is amplified by the N-type amplifying module and then outputted to the second data line through the second 2-to-1 multiplexer and the first output multiplexer, the second analog signal outputted by the second resistor ladder conversion module is amplified by the P-type amplifying module and then outputted to the third data line through the third 2-to-1 multiplexer and the second output multiplexer, the first output multiplexer outputs the external signal received by the first 2-to-1 multiplexer to the first data line, and the (N+1)th output multiplexer outputs the (2N)th analog signal received by the (2N−1)th 2-to-1 multiplexer to the next first data line; under a third operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first output multiplexer is coupled between the first 2-to-1 multiplexer and the second data line and coupled between the second 2-to-1 multiplexer and the first data line, the first analog signal outputted by the first resistor ladder conversion module is amplified by the N-type amplifying module and then outputted to the first data line through the second 2-to-1 multiplexer and the first output multiplexer, the second analog signal outputted by the second resistor ladder conversion module is amplified by the P-type amplifying module and then outputted to the second data line through the first 2-to-1 multiplexer and the first output multiplexer, and the (N+1) output multiplexer outputs the external signal received by the (2N+2)th 2-to-1 multiplexer to the next first data line; under a fourth operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first output multiplexer is coupled between the first 2-to-1 multiplexer and the second data line and coupled between the second 2-to-1 multiplexer and the first data line, the first analog signal outputted by the first resistor ladder conversion module is amplified by the P-type amplifying module and then outputted to the second data line through the first 2-to-1 multiplexer and the first output multiplexer, the second analog signal outputted by the second resistor ladder conversion module is amplified by the N-type amplifying module and then outputted to the third data line through the fourth 2-to-1 multiplexer and the second output multiplexer, the first output multiplexer outputs the external signal received by the second 2-to-1 multiplexer to the first data line and the (N+1)th output multiplexer output the (2N)th analog signal received by the (2N+2)th 2-to-1 multiplexer to the next first data line.

5. The driving apparatus of claim 2, further comprising N output multiplexers and (2N+1) 2-to-1 multiplexers, wherein the P-type amplifying module of the first channel and the N-type amplifying module of the second channel are both coupled to a first output multiplexer of the N output multiplexers, and a first 2-to-1 multiplexer of the (2N+1) 2-to-1 multiplexers is coupled to the first output multiplexer, the external signal, and the first data line, a second 2-to-1 multiplexer is coupled to the first output multiplexer and the second data line, a third 2-to-1 multiplexer is coupled to the first output multiplexer, the second output multiplexer, and the third data line, and the (2N+1) 2-to-1 multiplexer is coupled to the Nth output multiplexer and the next first data line.

6. The driving apparatus of claim 5, wherein under a first operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first output multiplexer is coupled between the P-type amplifying module and the first 2-to-1 multiplexer and coupled between the N-type amplifying module and the second 2-to-1 multiplexer, the first analog signal outputted by the first resistor ladder conversion module is amplified by the P-type amplifying module and then outputted to the first data line through the first output multiplexer and the first 2-to-1 multiplexer, the second analog signal outputted by the second resistor ladder conversion module is amplified by the N-type amplifying module and then outputted to the second data line through the first output multiplexer and the second 2-to-1 multiplexer, and the (2N+1)th 2-to-1 multiplexer receives the external signal and outputs the external signal to the next first data line; under a second operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first output multiplexer is coupled between the P-type amplifying module and the third 2-to-1 multiplexer and coupled between the N-type amplifying module and the second 2-to-1 multiplexer, the first analog signal outputted by the first resistor ladder conversion module is amplified by the N-type amplifying module and then outputted to the second data line through the first output multiplexer and the second 2-to-1 multiplexer, the second analog signal outputted by the second resistor ladder conversion module is amplified by the P-type amplifying module and then outputted to the third data line through the first output multiplexer and the third 2-to-1 multiplexer, the first 2-to-1 multiplexer receives the external signal and outputs the external signal to the first data line, and the (2N+1)th 2-to-1 multiplexer outputs the (2N)th analog signal received from the Nth output multiplexer to the next first data line; under a third operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first output multiplexer is coupled between the P-type amplifying module and the second 2-to-1 multiplexer and coupled between the N-type amplifying module and the first 2-to-1 multiplexer, the first analog signal outputted by the first resistor ladder conversion module is amplified by the N-type amplifying module and then outputted to the first data line through the first output multiplexer and the first 2-to-1 multiplexer, the second analog signal outputted by the second resistor ladder conversion module is amplified by the P-type amplifying module and then outputted to the second data line through the first output multiplexer and the second 2-to-1 multiplexer, and the (2N+1)th 2-to-1 multiplexer receives the external signal and outputs the external signal to the next first data line; under a fourth operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first output multiplexer is coupled between the P-type amplifying module and the second 2-to-1 multiplexer and coupled between the N-type amplifying module and the third 2-to-1 multiplexer, the first analog signal outputted by the first resistor ladder conversion module is amplified by the P-type amplifying module and then outputted to the second data line through the first output multiplexer and the second 2-to-1 multiplexer, the second analog signal outputted by the second resistor ladder conversion module is amplified by the N-type amplifying module and then outputted to the third data line through the first output multiplexer and the third 2-to-1 multiplexer, the first 2-to-1 multiplexer receives the external signal and outputs the external signal to the first data line and the (2N+1)th 2-to-1 multiplexer outputs the (2N)th analog signal received from the Nth output multiplexer to the next first data line.

7. The driving apparatus of claim 2, further comprising N 2-to-3 multiplexers, wherein the P-type amplifying module of the first channel and the N-type amplifying module of the second channel are both coupled to a first 2-to-3 multiplexer of the N 2-to-3 multiplexers, and the first 2-to-3 multiplexer is coupled to the first data line, the second data line, and the third data line, a second 2-to-3 multiplexer is coupled to the third data line, the fourth data line, and fifth data line, the Nth 2-to-3 multiplexer is coupled to the (2N−1)th data line, the (2N)th data line, and the next first data line.

8. The driving apparatus of claim 7, wherein under a first operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first 2-to-3 multiplexer is coupled between the P-type amplifying module and the first data line and coupled between the N-type amplifying module and the second data line, the first analog signal outputted by the first resistor ladder conversion module is amplified by the P-type amplifying module and then outputted to the first data line through the first 2-to-3 multiplexer, the second analog signal outputted by the second resistor ladder conversion module is amplified by the N-type amplifying module and then outputted to the second data line through the first 2-to-3 multiplexer; under a second operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first 2-to-3 multiplexer is coupled between the P-type amplifying module and the third data line and coupled between the N-type amplifying module and the second data line, the first analog signal outputted by the first resistor ladder conversion module is amplified by the N-type amplifying module and then outputted to the second data line through the first 2-to-3 multiplexer, the second analog signal outputted by the second resistor ladder conversion module is amplified by the P-type amplifying module and then outputted to the third data line through the first 2-to-3 multiplexer, the first 2-to-3 multiplexer outputs the external signal to the first data line, and the Nth 2-to-3 multiplexer outputs the (2N)th analog signal to the next first data line; under a third operation mode, the first resistor ladder conversion module of the first channel is coupled between the N-type digital/analog conversion module and the N-type amplifying module of the second channel, the second resistor ladder conversion module of the second channel is coupled between the P-type digital/analog conversion module and the P-type amplifying module of the first channel, the first 2-to-3 multiplexer is coupled between the P-type amplifying module and the second data line and coupled between the N-type amplifying module and the first data line, the first analog signal outputted by the first resistor ladder conversion module is amplified by the N-type amplifying module and then outputted to the first data line through the first 2-to-3 multiplexer, the second analog signal outputted by the second resistor ladder conversion module is amplified by the P-type amplifying module and then outputted to the second data line through the first 2-to-3 multiplexer, and the Nth 2-to-3 multiplexer outputs the external signal to the next first data line; under a fourth operation mode, the first resistor ladder conversion module of the first channel is coupled between the P-type digital/analog conversion module and the P-type amplifying module of the first channel, the second resistor ladder conversion module of the second channel is coupled between the N-type digital/analog conversion module and the N-type amplifying module of the second channel, the first 2-to-3 multiplexer is coupled between the P-type amplifying module and the second data line and coupled between the N-type amplifying module and the third data line, the first analog signal outputted by the first resistor ladder conversion module is amplified by the P-type amplifying module and then outputted to the second data line through the first 2-to-3 multiplexer, the second analog signal outputted by the second resistor ladder conversion module is amplified by the N-type amplifying module and then outputted to the third data line through the first 2-to-3 multiplexer, the first 2-to-3 multiplexer outputs the external signal to the first data line and the Nth 2-to-3 multiplexer outputs the (2N)th analog signal to the next first data line.
